(19) United States
(12) Patent Application Publication
(10) Pub. No.: US 2019/0053969 A1
(43) Pub. Date: Feb. 21, 2019

(54) EXERCISE DEVICE

(71) Applicant: BRAND DEVELOPERS LIMITED, Auckland (NZ)

(72) Inventor: Brendon TAIT, Auckland (NZ)

(73) Assignee: Brand Developers Limited, Auckland (NZ)

(21) Appl. No.: 16/078,575

(22) PCT Filed: Feb. 21, 2017
(86) PCT No.: PCT/NZ2017/050019

§ 371 Date: Aug. 21, 2018

(30) Foreign Application Priority Data
Feb. 22, 2016 (AU) 2016900622
Dec. 20, 2016 (AU) 2016905276

(51) Int. Cl. A61H 1/00

(52) U.S. Cl. CPC A61H 1/005; A61H 2201/0165; A61H 2201/1215; A61H 2203/0406; A61H 2201/1463; A61H 2201/164; A61H 2201/5038; A61H 2201/1418

(57) ABSTRACT

An exercise apparatus comprises a platform that is configured to support a user thereon. The apparatus also comprises at least first and second oscillation mechanisms that are arranged to cause movement of the platform. The first oscillation mechanism is arranged to impart drive to the platform to oscillate in a first frequency range and at a first amplitude. The second oscillation mechanism is arranged to impart drive to the platform to oscillate in a second frequency range and at a second amplitude. The first amplitude can be greater than the second amplitude. Further, each of the first and second oscillation mechanisms can be arranged to generally impart drive to the platform in substantially the same direction. The first and second mechanisms may operate through a drive element that combines drive imparted from the first and second oscillation mechanisms to cause the movement of the platform.

### TECHNICAL FIELD

This disclosure relates to an exercise apparatus and is disclosed in that context. The apparatus may also be applied in other fields (e.g. as an occupational therapy tool and for the rehabilitation of humans and animals). The apparatus includes a platform that allows a user to stand on the apparatus. The platform is arranged to impart movement to stimulate and strengthen the muscles of the user. While the apparatus is disclosed in this context, variations of the device allow for the platform to be replaced with alternate surface portions such that the device can be made suitable to exercise other body parts of the user.

### BACKGROUND ART

Stochastic training can be used to strengthen muscles. Stochastic training may not require the user to move. Instead, the user may be positioned on a vibration apparatus that vibrates and thereby stimulates the user's muscle fibres. In this way, a targeted physical strain may be applied to the user's muscles without overly straining the user's joints and tendons.

WO 2008/088276 discloses a vibration exercise apparatus that is able to vary the vibration frequency. The apparatus includes a vibration platform that a user stands on during exercise, a motor driven vibration mechanism to vibrate the platform, and a control system to increase or decrease the vibration frequency of the platform. The disclosed apparatus is not easily transportable as it requires a raised pillar and monitor. Additionally, the user's muscles are provided with the same stimulation in each exercise setting.

The above references to the background art do not constitute an admission that the art forms part of the common general knowledge of a person of ordinary skill in the art. The above references are also not intended to limit the application of the vibration exercise apparatus and method as disclosed herein.

### SUMMARY

Disclosed herein is an aspect of an exercise apparatus. The apparatus comprises a platform configured to support a user thereon and at least first and second oscillation mechanisms arranged to cause movement of the platform. The first oscillation mechanism is arranged to impart drive to the platform to oscillate in a first frequency range and at a first amplitude, and the second oscillation mechanism is arranged to impart drive to the platform to oscillate in a second frequency range and at a second amplitude. The first amplitude is greater than the second amplitude. Each of the first and second oscillation mechanisms is arranged to generally impart drive to the platform in substantially the same direction.

According to a further aspect, exercise apparatus is disclosed comprising a platform configured to support a user thereon, at least first and second oscillation mechanisms arranged to cause movement of the platform; the first oscillation mechanism is arranged to impart drive to the platform to oscillate in a first frequency range and at a first amplitude; and the second oscillation mechanism is arranged to impart drive to the platform to oscillate in a second frequency range and at a second amplitude; wherein the first and second mechanisms operate through a drive element, the drive element combining drive imparted from the first and second oscillation mechanisms to cause the movement of the platform.

When in the form of an exercise apparatus that a user is able to stand on according to the aspects disclosed above, the movement of the platform under operation of the first and second oscillation mechanisms allows for a user's muscles to experience apparent random stimulation during an exercise sequence. This type of exercise may be referred to as stochastic exercise. Reference herein to “stochastic” includes that the mechanism has and/or imparts random, apparently random or asynchronous variation in terms of movement, motion and user stimulation.

In some forms, the maximum of the second frequency range is greater than the maximum of the first frequency range. In some forms, the minimum of the second frequency range is greater than the minimum of the first frequency range. There may be some overlap between the maximum of the first frequency range and the minimum of the second frequency range. It is understood that a reference herein to frequency range includes the option of operating the first and second oscillation mechanisms at a fixed frequency, as well as the user being able to select and set a fixed frequency. Thus, in some embodiments, the first and second oscillation mechanisms may have the same or overlapping frequency ranges, and may be set to the same frequency or to different frequencies.

In an embodiment, the first and the second frequency ranges may be fixed to a first frequency and a second frequency and the second frequency is greater than the first frequency. In some forms, the exercise apparatus may further comprise more than two oscillation mechanisms which impart more than two frequency ranges to the platform. In particular, three oscillation mechanisms may be arranged to impart drive to the platform to oscillate in three frequency ranges. Additional oscillation mechanisms may be included to provide additional frequency ranges that may be imparted to the platform to create a more complex movement of the platform. Further, one oscillation mechanism may include two or more frequency ranges which allow the oscillation mechanism to switch between the two or more frequency ranges or to impart the two or more frequency ranges to the platform simultaneously.

In some forms, the first and second mechanisms may operate through a drive element to cause the movement of the platform. In some forms, the drive element may combine drive imparted from the first and second oscillation mechanisms to cause the movement of the platform. In some forms, the first and second oscillation mechanisms may be able to be operated independently through the drive element to cause the movement of the platform. In some forms, the drive element may include a drive head that engages the platform. In some forms, the drive element may comprise a linkage connecting the first and second oscillation mechanisms. In some forms, the drive head may be mounted to the linkage.

In some forms, the first and second oscillation mechanisms may include respective first and second eccentric arrangements that oscillate to impart the drive to the platform. In some forms, the first and second eccentric arrangements may be pivotally connected to the linkage.

In some forms, a first drive motor may cause oscillation of the first and second eccentric arrangements.

In some forms, the first oscillation mechanism may further comprise a first translation mechanism arranged to translate the output from the first motor to the first eccentric arrangement so as to impart drive to the platform to oscillate at the first frequency and at the first amplitude, and wherein the second oscillation mechanism may further comprise a second translation mechanism arranged to translate the output from the first motor to the second eccentric arrangement so as to impart drive to the platform to oscillate at the second frequency and at the second amplitude. In some forms, the first translation mechanism may comprise a first driven pulley, a first endless belt and a first driver pulley, the first endless belt extends between the first driven pulley and the first driver pulley. In some forms, the second translation mechanism may comprise a second driven pulley, a second endless belt, and a second driver pulley, the second endless belt extends between the second driven pulley and the second driver pulley.

In some forms, the first driven pulley may have a different diameter to the second driven pulley. In some forms, the first driver pulley may have a different diameter to the second driver pulley. The revolutions of each driver pulley affect the revolutions of its corresponding driven pulley. For example, changing the diameter of any one of the pulleys can affect the frequency of each of the first and second oscillation mechanisms and therefore can overall affect the frequency of the platform movement. In particular, increasing the size of the driven pulley in relation to the driver pulley means that, for every revolution of the larger driven pulley, the smaller driver pulley rotates faster. Further, increasing the size of the first driven pulley in relation to the second driven pulley means that the first translation mechanism will translate the output from the first motor at a lower frequency than the second translation mechanism. Similar or opposite outcomes can be achieved by changing the diameter of the first and second driver pulleys. In some forms, the second driven pulley may be smaller in diameter than the first driven pulley. In some forms, the first driver pulley and the second driver pulley may be driven by a drive shaft of the first drive motor and rotate about an axis of the first motor shaft drive.

In some forms, the first oscillation mechanism may comprise a first axle that is arranged to rotate about a first axis. The first axis may be substantially parallel to the first motor drive shaft axis. The second oscillation mechanism may comprise a second axle arranged to rotate about a second axis of the second axle. The second axis may be substantially parallel to the first motor drive shaft axis. In some forms, the first driven pulley and the second driven pulley may rotate about the first axis and the second axis respectively.

In some forms, the first eccentric arrangement may comprise a first cam having an off centre mounting, the mounting being arranged to receive the first axle such that rotation of the first axle causes an eccentric rotation of the first cam. The second eccentric arrangement may comprise a second cam having an off centre mounting, the mounting being arranged to receive the second axle such that rotation of the second axle causes an eccentric rotation of the second cam.

In some forms, the first oscillation mechanism may further comprise a first motor that causes oscillation of the first eccentric arrangement, and the second oscillation mechanism may further comprise a second motor that causes oscillation of the second eccentric arrangement.

In some forms, the first oscillation mechanism may be arranged to translate the output from the first motor to the first eccentric arrangement to so as to impart drive to the platform to oscillate at the first frequency and at the first amplitude.

In some forms, the first translation mechanism may comprise a first driven pulley, a first endless belt and a first driver pulley. The first endless belt may extend between the first driven pulley and the first driver pulley.

In some forms, the second eccentric arrangement may be driven by a drive shaft of the second drive motor and may rotate about an axis of the second motor shaft drive.

In some forms, the first oscillation mechanism may comprise a first axle that is arranged to rotate about a first axis of the first axle. The first axis may be substantially parallel to the first motor drive shaft axis. The first eccentric arrangement may comprise a first cam having an off centre mounting. The mounting may be arranged to receive the first axle such that rotation of the first axle causes an eccentric rotation of the first cam. The second eccentric arrangement may comprise a second cam having an off centre mounting. The mounting may be arranged to receive the second motor shaft such that rotation of the second motor shaft causes an eccentric rotation of the second cam.

In some forms, the first eccentric arrangement may further comprise a first cam housing portion housing the first cam such that eccentric rotation of the first cam causes a corresponding substantially linear movement of the first cam housing portion between a raised position and a lowered position. In some forms, the first cam housing portion may be mounted to the drive element. In some forms, the linkage of the drive element may be pivotally connected to the first cam housing portion.

In some forms, the second eccentric arrangement may further comprise a second cam housing portion housing the second cam such that eccentric rotation of the second cam causes substantially linear movement of the second cam housing portion between a raised position and a lowered position. In some forms, the second cam housing portion may be mounted to the drive element. In some forms, the linkage of the drive element may be pivotally connected to the second cam housing portion.

In some forms, the exercise apparatus may further comprise an apparatus housing for supporting the platform and the first and second oscillation mechanisms. In some forms, the platform may be pivotally mounted to the apparatus housing such that the platform is able to pivot about a platform pivotal axis.

In some forms, the direction of movement of the first and second oscillation mechanisms may be substantially in the same plane.

According to a further aspect, an exercise apparatus is disclosed. The apparatus may comprise a platform configured to support a user thereon. The platform may have first and second surface portions. A first mechanism may be arranged to cause a first movement of the first surface portion. A second mechanism may be arranged to cause a second movement of the second surface portion.

The relative movement between the first and second surface portions may be stochastic. When in the form of an exercise apparatus that a user is able to stand on, this can allow for a user's muscles in the left leg to be provided with a different stimulation to the user's muscles in the right leg, during an exercise sequence. The movements may take the form of one or more of the following movement types:—
a variation in the vertical (e.g. substantially perpendicular to a face of the first and second surface portions when they are in the form of footplates) frequency. In other words, the surface portions move up and down at different frequencies to one another;
a variation in the horizontal (e.g. substantially parallel to a face of the first and second surface portions when they are in the form of footplates) frequency. This type of movement, when the apparatus takes the form of a device that is stood on, can be side to side, back and forth, lateral, or rotational movement. In other words, the surface portions can oscillate from side to side or back and forth at different frequencies to one another; and
a variation in the pivotal movement (e.g. amplitude). For example, the first surface portion can oscillate at a different amplitude to the second surface portion.

In some forms, the first surface portion may be separated so as to move independently of the second surface portion. This can allow a user to place a separate body part (e.g. a right and left foot) on respective independent portions of the apparatus.

In some forms, the relative movement between the first and second surface portions may be in the form of at least one of:—
a lateral variation in movement between the first and second surface portions, the lateral movement being along an axis that is substantially parallel to a face of the first and second surface portions;
a rotational variation in movement between the first and second surface portions, the rotational movement being along a plane that is substantially parallel to a face of the first and second surface portions; and
another lateral variation in movement between the first and second surface portions, the another lateral movement being along an axis that is substantially perpendicular to the face of the first and second surface portions.

In some forms, the first and second oscillation mechanisms may form part of an oscillation mechanism having first and second eccentric arrangements. The first and second eccentric arrangements may be arranged to cause the first surface portion to oscillate stochastically relative to the second surface portion. In some forms, the oscillation mechanism may include two or more eccentric arrangements.

In some forms, the first eccentric arrangement may be arranged to cause the first surface portion to oscillate at a first frequency, and the second eccentric arrangement may be arranged to cause the second surface portion to oscillate at a second frequency.

In some forms, the first frequency may be different to the second frequency. In this regard, the apparatus may be configured such that, in general, the oscillation frequency (e.g. lateral movement of the surface portions up and down, and/or side to side, and or back and forth) of the first surface portion may be different to the oscillation frequency of the second surface portion (although the physical position of the surface portions may cross-over to be the same during an exercise sequence).

In some forms, the first and second eccentric arrangement may be respectively arranged to engage with directly or indirectly to cause the first and second surface portions to oscillate.

In some forms, the oscillation mechanism may further comprise a motor and a motor drive shaft for driving the oscillation mechanism, wherein the motor shaft rotates about a motor drive shaft axis. This arrangement advantageously allows for a single motor to cause the two surface portions to oscillate at different oscillation frequencies.

In some forms, the oscillation mechanism may further comprise a first translation mechanism arranged to translate the output from the motor drive shaft to the first eccentric arrangement so as to cause the first eccentric arrangement to oscillate at the first frequency upon rotation of the motor shaft.

In some forms, the first translation mechanism may comprise a first pulley arrangement. The first pulley arrangement may comprise a first endless belt that extends between a first driven pulley of the first oscillation mechanism and a first driver pulley of the motor shaft.

In some forms, the oscillation mechanism may further comprise a second translation mechanism arranged to translate the output from the motor drive shaft to the second oscillation mechanism so as to cause the second oscillation mechanism to oscillate at the second oscillation frequency upon rotation of the motor shaft. In some forms, the second translation mechanism may comprise a second pulley arrangement. The second pulley arrangement may comprise a second endless belt that extends between a second driven pulley of the second oscillation mechanism and a second driver pulley of the motor shaft.

In some forms, the first driven pulley may have a different diameter to the second driven pulley. In some forms, the first driver pulley may have a different diameter than the second driver pulley. The revolutions of the driver pulley affect the revolutions of the driven pulley. Changing the diameter of any one of the pulleys can affect the frequency of each of the oscillation mechanisms and therefore can overall affect the movement of the exercise apparatus. In particular, increasing the size of the driven pulley in relation to the driver pulley means that for every revolution of the larger driven pulley, the smaller driver pulley rotates faster. Further, increasing the size of the first driven pulley in relation to the second driven pulley means that the first translation mechanism will operate at a lower frequency than the second translation mechanism. The same can be said about changing the diameter of the first and second driver pulleys. Advantageously, this arrangement provides a relatively inexpensive mechanism that is able to cause the oscillation of the two surface portions.

In some forms, the first oscillation mechanism may comprise a first axle that is arranged to rotate about an axis of the first axle. The first axle axis may be substantially parallel to the motor drive shaft axis.

In some forms, the second oscillation mechanism may comprise a second axle arranged to rotate about an axis of the second axle. The second axle axis may be substantially parallel to the motor drive shaft axis.

In some forms, the first eccentric arrangement may be configured to engage with directly or indirectly to cause the first surface portion to oscillate.

In some forms, the first eccentric arrangement may comprise a first cam having an off centre aperture formed therethrough. The aperture may be arranged to receive the first axle such that rotation of the first axle causes an eccentric rotation of the first cam.

In some forms, the second eccentric arrangement may comprise a second cam having an off centre aperture formed therethrough. The aperture may be arranged to receive the second axle such that rotation of the second axle causes an eccentric rotation of the second cam.

In some forms, the first eccentric arrangement may further comprise a first cam housing portion mounted to the first cam such that eccentric rotation of the first cam causes a corresponding eccentric rotation of the first cam housing portion between a first raised position and a second lowered position.

In some forms, the first cam housing portion may be arranged to engage the first surface portion such that eccentric rotation of the cam housing portion between the first raised position and the second lowered position causes the first surface portion to oscillate between a lifted position and a lowered position, thereby imparting oscillation to the first surface portion.

In some forms, the first cam housing portion may further comprise a first mounting portion arranged to mount the first surface portion to the first eccentric arrangement.

In some forms, the second eccentric arrangement may further comprise a second cam housing portion mounted to the second cam such that eccentric rotation of the second cam causes a corresponding eccentric rotation of the second cam housing portion between a first raised position and a second lowered position.

In some forms, the second cam housing portion may be arranged to engage the second surface portion such that eccentric rotation of the second cam housing portion between the first raised position and the second lowered position causes the second surface portion to oscillate between a lifted position and a lowered position, thereby imparting oscillation to the second surface portion.

In some forms, the second cam housing portion may further comprise a second mounting portion arranged to mount the second surface portion to the second eccentric arrangement.

In some forms, the apparatus may further comprise an apparatus housing for supporting the first and second surface portions and the first and second mechanisms.

In some forms, the first surface portion may be pivotally mounted to the housing such that the first surface portion is able to pivot about a first axis. The first axis may be substantially parallel to the motor drive shaft axis.

In some forms, the second surface portion may be pivotally mounted to the housing such that the second surface portion is able to pivot about a second axis. The second axis may be substantially parallel to the first axis.

In some forms, spaced support arms may each extend down to a pivot pin from opposing and facing edges of the first and second surface portions. The first axis may be coincident with the second axis along the pivot pin.

In some forms, the first and second axes may be spaced from the motor shaft axis.

Also disclosed herein is a method of exercising. The method may comprise supporting a left foot of a user and a right foot of the user; and causing the left foot of the user to move with a first motion and simultaneously causing the right foot of the user to move with a second motion, and such that a difference in motion between the first and second feet is stochastic. In another form, the method may comprise supporting a first body part of a user and a second body part of the user; and causing the first body part of the user to move with a first motion and simultaneously causing the second body part of the user to move with a second motion, and such that a difference in motion between the first and second body parts is stochastic.

In some forms, the first motion may result in the left foot of the user oscillating at a first frequency. The second motion may result in the right foot of the user oscillating at a second frequency.

In some forms, the first frequency may be different and/or may vary differently to the second frequency.

In some forms, the method may employ the exercise apparatus disclosed above, wherein the user's left foot is supported at the first surface portion and the user's right foot is supported at the second surface portion.

Also disclosed herein is an apparatus for stochastic exercise. The apparatus may comprise a platform configured to support a user thereon. The platform may have first and second surface portions. The apparatus may also comprise an oscillation mechanism comprising first and second oscillation mechanisms that are respectively arranged to cause the first and second surface portions to oscillate. The apparatus may further comprise a motor having a shaft for driving the oscillation mechanism. The apparatus may additionally comprise a first translation mechanism arranged to translate the output from the motor shaft to the first eccentric arrangements so as to cause a first oscillation mechanism to oscillate at a first frequency upon rotation of the motor shaft. The apparatus may also comprise a second translation mechanism arranged to translate the output from the motor shaft to the second oscillation mechanism so as to cause a second platform to oscillate at a second frequency upon rotation of the motor shaft.

In some forms, the first frequency may be different to the second frequency. In some forms, the first surface portion may be separated so as to oscillate independently of the second surface portion.

In some forms, the first and second translation mechanisms may each comprise one of: a pulley and belt mechanism; a gear mechanism; a worm drive; and a magnet. In some forms, the pulley and belt mechanism may be as described above. In some forms, the platform, oscillation mechanisms and motor may be as described above.

### BRIEF DESCRIPTION OF THE DRAWINGS

Embodiments will now be described by way of example only, with reference to the accompanying drawings in which

FIG. 1 shows an isometric front view of an embodiment of the exercise apparatus;

FIG. 2 shows a perspective view of an embodiment of an oscillation mechanism;

FIG. 3 shows an isometric view of an eccentric arrangement of the oscillation mechanism shown in FIG. 2;

FIG. 4 shows an exploded view of the eccentric arrangement shown in FIG. 3;

FIG. 5 shows a footplate of the apparatus shown in FIG. 1;

FIG. 6 shows a footplate of the apparatus shown in FIG. 6 pivotally mounted to another identical footplate;

FIG. 7 shows an exploded view of the apparatus shown in FIG. 1.

FIG. 8 shows an exploded view of another embodiment of the exercise apparatus;

FIG. 9 shows a perspective view of the exercise apparatus shown in FIG. 8;

FIG. 10 shows a perspective view of a further embodiment of the exercise apparatus;

FIG. 11 shows a side view of the exercise apparatus shown in FIG. 10;

FIG. 12 shows a perspective view of an embodiment of an exercise machine components including the components of the exercise apparatus shown in FIG. 10;

FIG. 13 shows a side view of the exercise machine shown in FIG. 12;

FIG. 14 shows an exploded perspective view of the exercise machine components shown in FIG. 12;

FIG. 15 shows an exploded side view of the exercise machine shown in FIG. 12;

FIG. 16 shows an exploded view of the exercise machine shown in FIG. 12 including an embodiment of external fittings and control system; and

FIG. 17 shows a perspective view of a further embodiment of an exercise apparatus.

### DETAILED DESCRIPTION

In the following detailed description, reference is made to accompanying drawings which form a part of the detailed description. The illustrative embodiments described in the detailed description, depicted in the drawings and defined in the claims, are not intended to be limiting. Other embodiments may be utilised and other changes may be made without departing from the spirit or scope of the subject matter presented. It will be readily understood that the aspects of the present disclosure, as generally described herein and illustrated in the drawings can be arranged, substituted, combined, separated and designed in a wide variety of different configurations, all of which are contemplated in this disclosure.

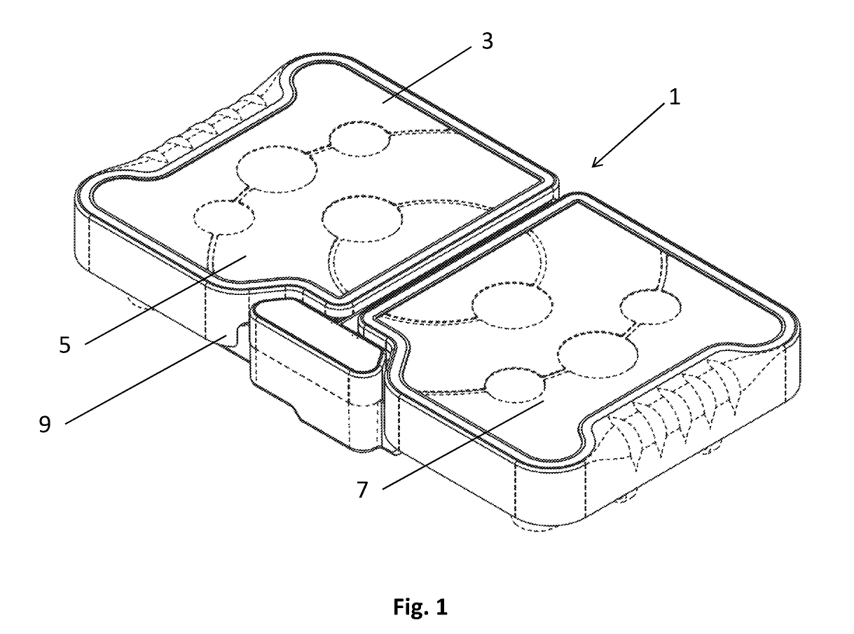

Disclosed herein is apparatus for exercising in the form of an exercise apparatus 1. FIG. 1 shows an isometric front view of the exercise apparatus 1. The apparatus 1 includes a platform 3 configured to support a user thereon.

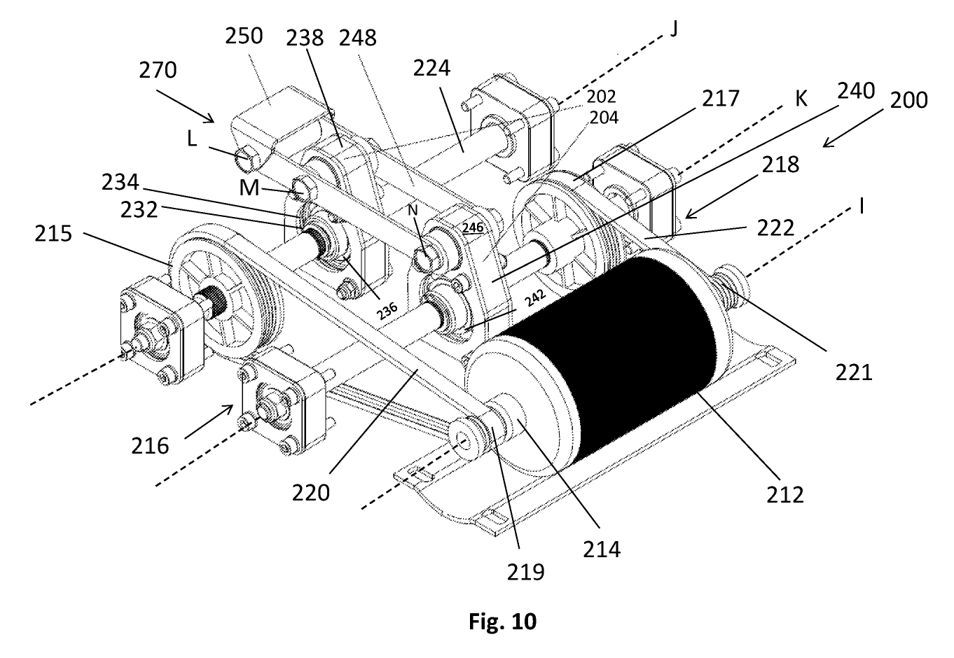

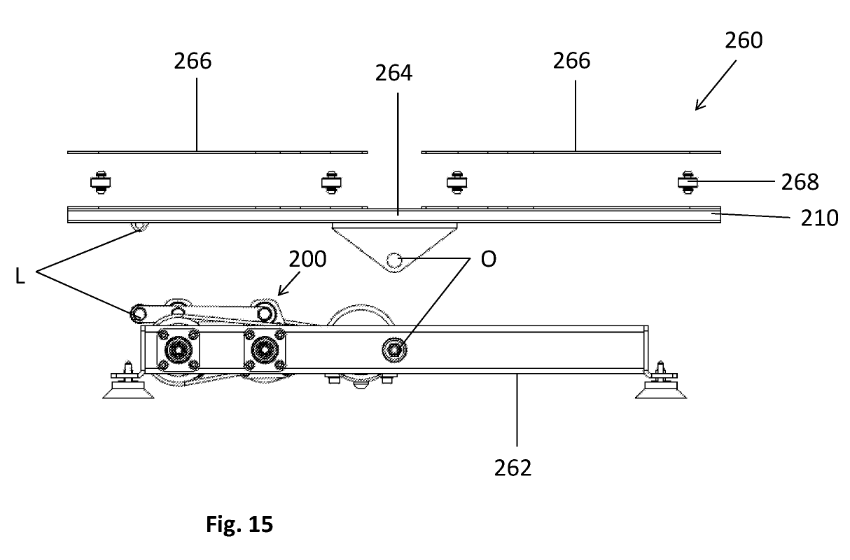

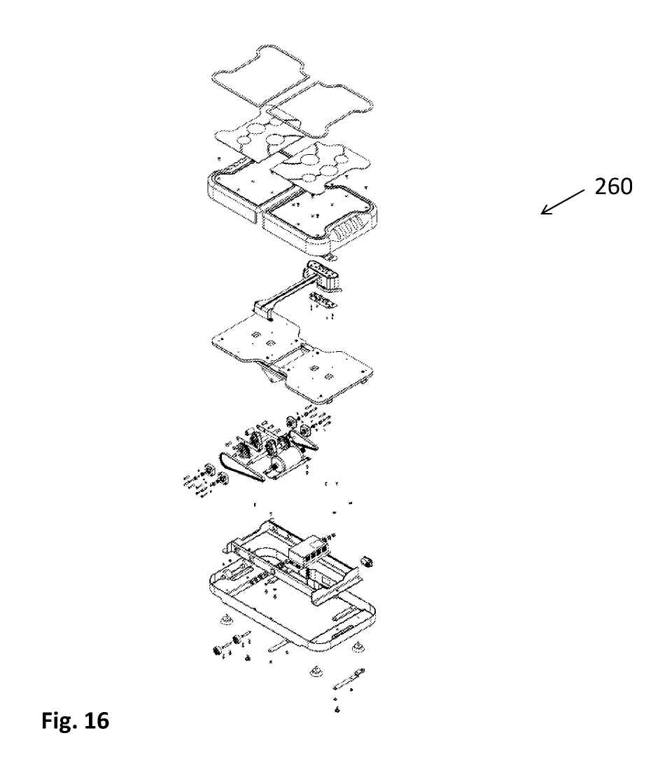

In a detailed form, the platform 3 includes first and second surface portions, in the form of footplates 5, 7 that are separate from one another. In another form, the first and second footplates may be integrated with one another so as to form a single surface, but be able to operate (i.e. oscillate or otherwise move) at two or more different frequencies (as shown in FIGS. 10 to 17). The first 5 and second 7 footplates of the platform 3 are arranged to support a right and left foot of a user (i.e. a user is able to stand on the apparatus with their right and left feet spaced apart). The exercise apparatus 1 includes a housing 9 within which an oscillation mechanism is positioned.

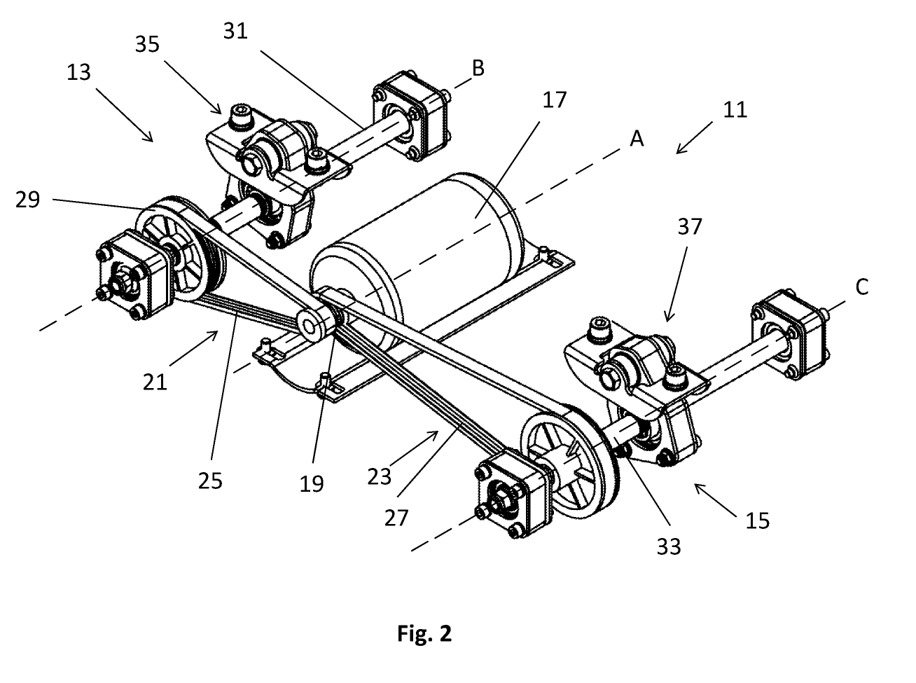

An oscillation mechanism 11 of an embodiment of the exercise apparatus will now be described with reference to FIG. 2. The oscillation mechanism includes first 13 and second 15 oscillation mechanisms. The first oscillation mechanism 13 is arranged to cause the first footplate 5 to oscillate at a first frequency. The second oscillation mechanism 15 is arranged to cause the second footplate 7 to oscillate at a second frequency. In the detailed form, the first frequency may be different to the second frequency (e.g. in one form, the first surface portion may oscillate at a higher frequency than the second surface portion).

As will become evident to the skilled addressee, the arrangement of the oscillation mechanisms 13, 15 determine the frequency differential between the first 5 and second 7 footplates. As previously mentioned, in the detailed embodiment, the first footplate 5 is separated from the second footplate 7 so as to oscillate independently of the second footplate 7. Advantageously, this arrangement may allow for the frequency of the footplates 5, 7 to be out of sync with one another (e.g. randomly asynchronous). In other words, the frequency of one footplate may be higher than the frequency of the other footplate. A frequency differential between the right and left feet of the user has been discovered to further stimulate the muscles during exercise to enhance the user's workout. Better training results may be achieved by the disclosed exercise apparatus 1, as the variation in frequency between the left and right footplates makes it more difficult for the body to adapt to the frequency. In one form, the first footplate 5 may oscillate at a frequency of between 1-60 Hz. In one form, the first footplate 5 oscillates at a frequency of between 1-50 Hz. In one form, the first footplate 5 oscillates at a frequency of between 1-35 Hz. In one form, the second footplate 7 oscillates at a frequency of between 1-60 Hz. In one form, the second footplate 7 oscillates at a frequency of between 0-50 Hz. In one form, the second footplate 7 oscillates at a frequency of between 1-35 Hz. In one form, the frequency differential between the first and second footplates is between 0.1-10 Hz. As will be evident to the skilled addressee, the frequency of either footplate (or surface portion if the apparatus is designed for an alternate body part) and the frequency differential between footplates can depend on the mechanisms used and the skill of the user.

The first 13 and second 15 oscillation mechanisms are respectively arranged to engage with and cause the first 5 and second 7 footplates to oscillate. The oscillation mechanism 11 includes a motor 17 and a motor drive shaft 19 for driving the oscillation mechanisms 13, 15. The motor shaft 19 rotates about a motor drive shaft axis A. The motor 17 can comprise a variable speed drive, or be a stepper motor. The motor 17 can be controlled from a programmable controller, to have ranges and sequences of operating speeds.

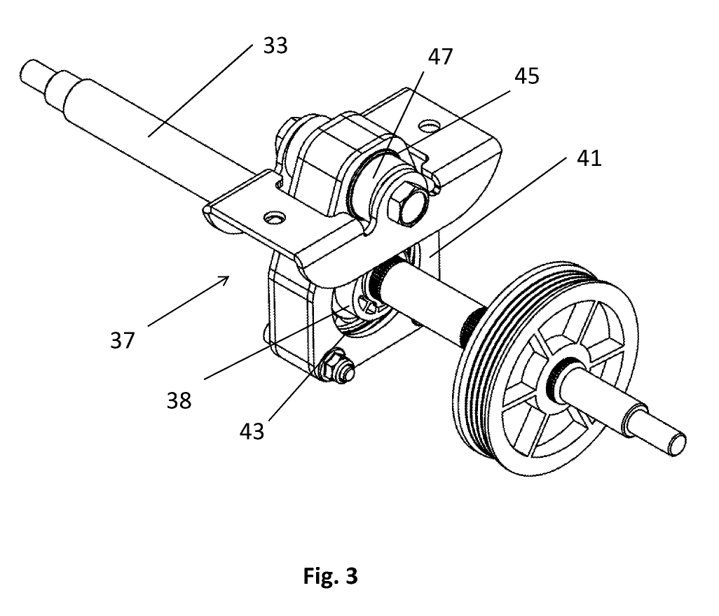

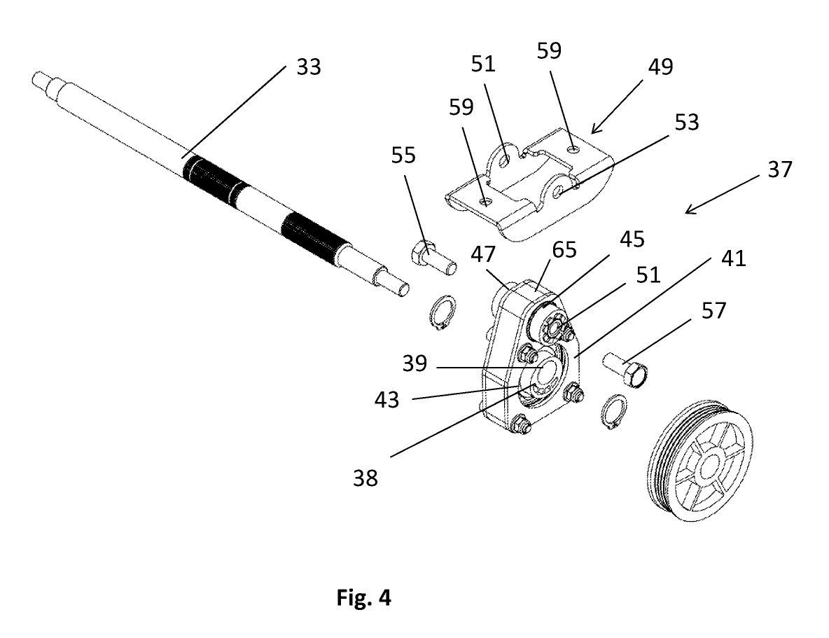

The first oscillation mechanism 13 includes a first eccentric arrangement 35 configured to engage with and cause the first footplate 5 to oscillate. The second oscillation mechanism 15 includes a second eccentric arrangement 37 configured to engage with and cause the second footplate 7 to oscillate. The first 35 and second 37 eccentric arrangements are mirror images of one another. The second eccentric arrangement 37 will now be described in further detail with reference to FIGS. 3 and 4.

The oscillation mechanism 11 also includes a first translation mechanism, in the form of a first pulley and belt mechanism 21 that translates the output from the motor 17 to the first eccentric arrangement 35 so as to cause the footplate 5 to oscillate at the first frequency upon rotation of the motor shaft 19. In alternate embodiments, the translation mechanism may be in the form of a gear mechanism, a worm drive, a magnet, or other mechanism that is able to translate rotary, oscillating or pivotal movement. The oscillation mechanism 11 includes another (e.g. second) translation mechanism, in the form of second pulley and belt mechanism 23 that translates the output from the motor 17 to the second oscillation mechanism 15 so as to cause the second eccentric arrangement 37 to oscillate at the second frequency upon rotation of the motor shaft 19.

The first pulley arrangement 21 includes an endless belt 25 that extends between a pulley of the first oscillation mechanism 13 and a pulley of the motor shaft 19. The second pulley arrangement 23 also includes an endless belt 27 that extends between a pulley of the second oscillation mechanism 15 and a pulley of the motor shaft 19. In the detailed embodiment, the drive shaft 19 that is driving belt 27 has a larger diameter than the pulley on the drive shaft 19 that is driving belt 25. Since both pulleys and endless belts 25, 27 are driven by a single source (i.e. the motor shaft 19), the frequency of rotation of the pulley 29 is therefore slower or lower. It is understood that in alternative embodiments, the pulleys in line with the oscillation mechanisms or the pulleys in line with the motor shaft may be different diameters to affect the frequency of rotation of the cam within the cam housing.

The first oscillation mechanism 13 includes a first axle 31 arranged to rotate about a first axle axis B. The first axle axis B and the second axle axis C are substantially parallel to the motor drive axis A. It is also understood that the first axle axis B may be substantially in the same plane, transverse to or perpendicular to the motor drive shaft axis A. The second oscillation mechanism 15 includes a second axle 33 arranged to rotate about a second axle axis C. The second axle axis C is also substantially parallel (and in may be substantially in the same plane) to the motor drive shaft axis A, as well as to the first axle axis B. It is also understood that the second axle axis C may be transverse to, or perpendicular to the motor drive shaft axis A and/or the first axle axis B. In use, rotation of the motor shaft 19 about the axis A drives the first 31 and second 33 axles such that they respectively rotate about axis B and C. The differential in pulley diameters causes a differential in rotational speed of the first 31 and second 33 axles about the axis B and C. It is understood that each of the axes and the motor drive axle do not need to be substantially parallel to one another, and may be transverse or perpendicular.

FIG. 3 shows an isometric view of the second eccentric arrangement 37 connected to the second axle 33. FIG. 4 shows an exploded view of the second eccentric arrangement 37. The second eccentric arrangement 37 includes an eccentric cam 38 having an off centre aperture 39 formed therethrough. The aperture 39 is arranged to receive the second axle 33 such that rotation of the second axle 33 causes an eccentric rotation of the eccentric cam 38. The second eccentric arrangement 37 also includes a cam housing portion 41 mounted to the second cam 38 such that eccentric rotation of the cam 38 causes a corresponding eccentric rotation of the cam housing portion 41 between a first raised position and a second lowered position. The second cam housing portion 41 is arranged to engage the second footplate 7 such that eccentric rotation of the cam housing portion 41 between the first raised position and the second lowered position causes the second footplate 7 to oscillate between a lifted position and a lowered position. The cam housing portion also includes a first aperture 43 formed therethrough that corresponds with aperture 39 such that the axle 33 is able to extend through the housing 41.

The second cam housing portion 41 includes a second aperture 45 formed therethrough that receives a spindle 47 configured to mount the second cam housing portion to a mounting bracket 49. The spindle 47 and mounting bracket 49 include apertures 51, 53 that in use are aligned to receive fasteners 55, 57 that connect the spindle 47 to the mounting bracket 49. The mounting bracket 49 includes a pair of apertures 59 that are configured to receive further fasteners (not shown) to fasten the mounting bracket 49 to the footplate 7.

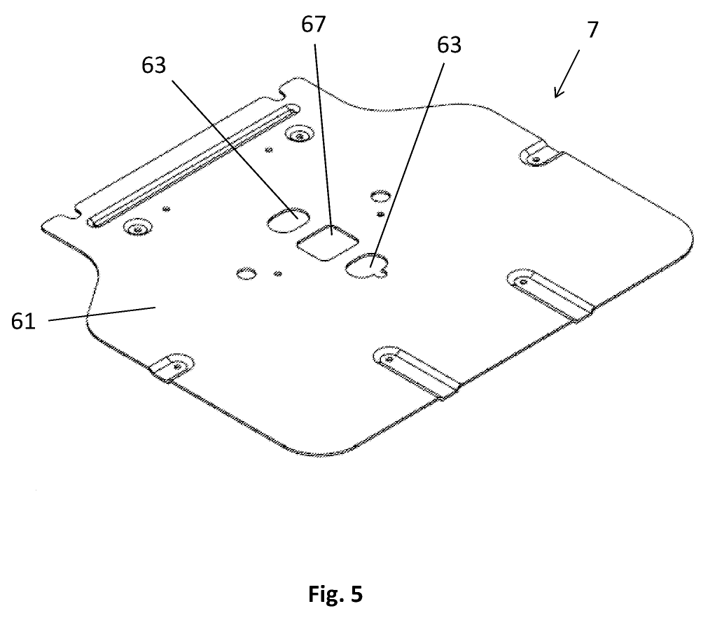

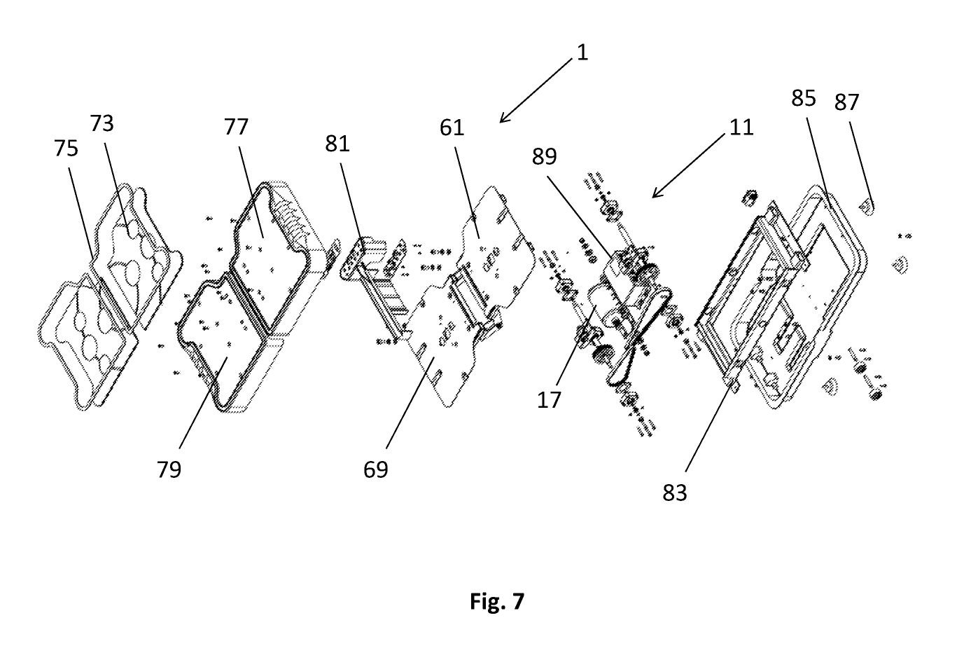

The portion of the second footplate 7 that is mounted to the second eccentric arrangement 37 is shown in FIG. 5. The second footplate 7 includes a plate 61 having apertures 63 that in use align with apertures 59 through which a pair of fasteners are positioned to fasten the mounting bracket 49 to the plate 51. In the detailed form, the plate 61 is metal. In alternate forms, non-metallic, lighter weight materials (e.g. plastic, optionally fibre-reinforced) can be used to enable the footplate to be mounted to the oscillation mechanism. The metal plate 61 includes another aperture 67 for receipt of the head 65 of the cam housing 41. The aperture 67 is larger than the head 65 of the cam housing 41 to allow the head 65 to move with respect to the footplate 61. The footplate 7 includes a rubber mat that is spaced from and positioned over the metal plate 61 such that a user does not stand directly on the metal plate 61 or oscillation mechanism 11. A sub-assembly housing (see FIG. 7, sub-assembly 83) is positioned within the housing 9 of the exercise apparatus 1 for supporting the first and second footplates 5, 7, the motor 17, the first and second eccentric arrangements 13, 15 and the first and second axles 31, 33.

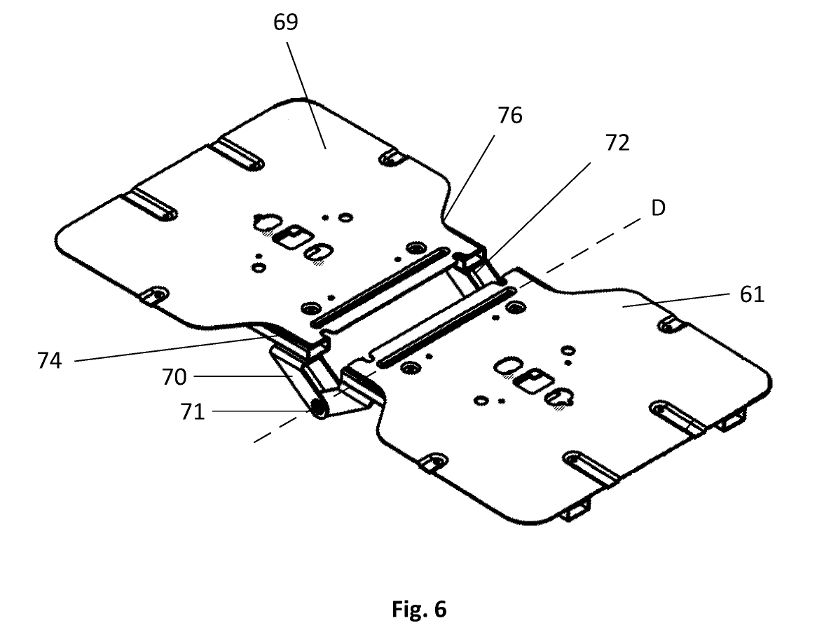

As shown in FIG. 6, the first footplate 5 includes a metal plate 69 that is a mirror image of the second metal plate 61. The first and second footplates 69, 61 are pivotally mounted to the sub assembly housing such that the footplates are able to rotate about an axis D. The axis D is substantially parallel to the motor shaft axis. In the detailed embodiment, the first and second footplates share a common pivotal mounting 71 (i.e. the footplates 69, 61 are also pivotally mounted to one another) so that both footplates pivot about the same axis D (i.e. the axis about which the first footplate pivots is coincident with the axis about which the second footplate pivots). In alternate embodiments, the first and second footplates have separate pivotal mountings and pivot about separate axes.

Footplates 61, 69 include spaced support arms 70, 72 that are connected to opposing facing edges 74, 76 of each footplate. The supports arms 70, 72 extend down to the pivotal mounting point (e.g. a pivot pin) that pivotally connects the footplates to each other and to the sub-assembly 83 (see FIG. 7). As such, the axis (i.e. the first axis) about which the first footplate 69 oscillates is coincident with the axis (i.e. the second axis) about which the second footplate 61 oscillates. The common axis (shown as D in FIG. 6) extends between the pivotal mounting points 71 on either side 74, 76 of the footplates.

FIG. 7 shows an exploded view of the apparatus 1 showing the major components, including rubber mats 73 and rubber ending 75 of the footplates, the right hand foot platform 77 and the left hand foot platform 79, control panel 81, the metal footplates 61, 69, the oscillation mechanism 11, the sub-assembly housing (base frame) 83, the base 85 and the feet 87.

In the detailed embodiment, the motor 17 is driven by a variable speed drive 89 that is controlled by a control system. The user is able to increase or decrease the motor speed, and thus the frequency of the footplates 61, 69, via the control panel 81. Additionally, the control system may have pre-set settings that a user can select. For example, in one exemplary setting, the motor speed constantly changes (e.g. increases and decreases) to provide a seemingly random (i.e. stochastic) movement to the muscles of the user. In the detailed embodiment, the apparatus 1 is approximately 700 mm in length, 400 mm in width and 100 mm in depth. All apparatus is effectively a self-contained unit and is able to be easily transported (i.e. picked up and carried) by the user. For example, a user may store the apparatus 1 in a cupboard and then move the apparatus to another room for training.

As will be evident to the skilled addressee, alternative options are available for the oscillation mechanism that would achieve a similar frequency differential between the first and second footplates. In the detailed embodiment, a single motor drive two pulley arrangements having pulleys of differing diameters, therefore turning the first and second axles of the first and second oscillation mechanisms at different rotational speed (i.e. rpm). This arrangement is able to produce an erratic pattern of reciprocation.

In an alternate embodiment, two motors can be used to independently drive the first and second axles of the first and second oscillation mechanisms. To adjust the vibration frequency, the speed of the motors may be adjusted independently, and/or the pulley diameters may be altered. This embodiment will be discussed in more detail below. In another alternative embodiment, eccentric weighted motors may be mounted to each of the footplates. The rotational speed (i.e. rpm) of the motor may control the speed of the reciprocating motion (i.e. the frequency), including employing a variable speed motor or a stepper motor etc.

In another alternate embodiment, a differential may be used to achieve a frequency differential. In this embodiment, the load placed on each footplate may cause the differential output ratio to become dissimilar, thereby creating an erratic reciprocating frequency (i.e. the frequency differential between the footplates).

In another alternate embodiment, eccentric idler pulleys may be positioned on the pulley belt to achieve a variable rate of reciprocation between the footplates. In another alternate embodiment, hydraulic mechanisms may be used to achieve a variable rate of reciprocation between the footplates.

In yet another alternate embodiment, a ‘random orbital mechanism’ may be positioned on the driveshaft of the motor followed by a backing plate with linkages that mount to the footplates. In this embodiment, the oscillating motion may be translated through the linkages to the footplates, thereby causing an infinite variation in frequency.

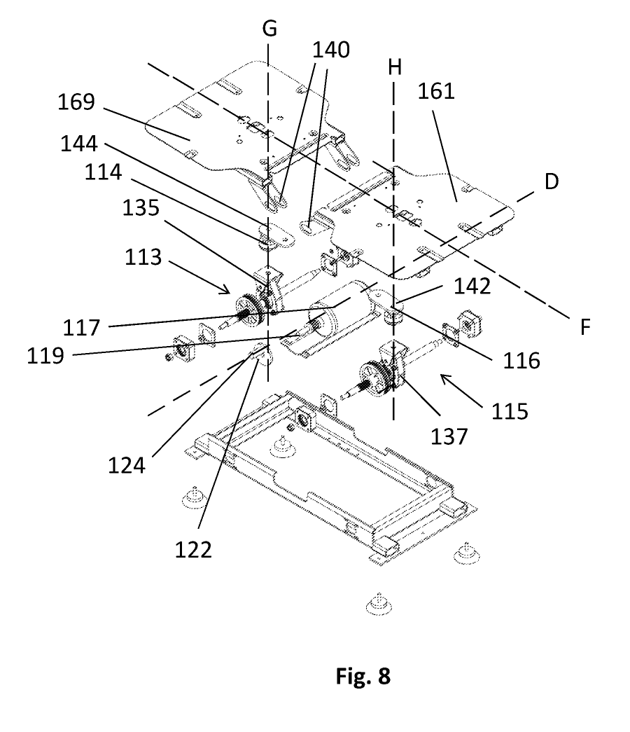

FIG. 8 shows an exploded perspective view of another embodiment of the exercise device. In this embodiment, each footplate 161, 169 oscillates about two axes D and F (FIG. 8). In this embodiment, the device includes a similar oscillation mechanism to that described with respect to FIG. 2. Specifically, the device includes first 113 and second 115 oscillation mechanisms that are arranged to cause the footplates 169, 161 to oscillate at different frequencies about axis D. The oscillation mechanism includes a motor 117 and a motor drive shaft 119 for driving the oscillation mechanism. The motor shaft 119 rotates about a motor drive shaft axis D. The motor 117 can comprise a variable speed drive, or be a stepper motor. The motor 117 can be controlled from a programmable controller, to have ranges and sequences of operating speeds. The oscillation mechanism includes translation mechanisms, in the form of a pulley and belt mechanisms that translate the output from the motor drive shaft 119 to the first 115 and second 113 oscillation mechanisms. The first 113 and second 115 oscillation mechanisms include eccentric cams 135, 137 configured to engage with and cause the footplates 161, 169 to oscillate about axis D.

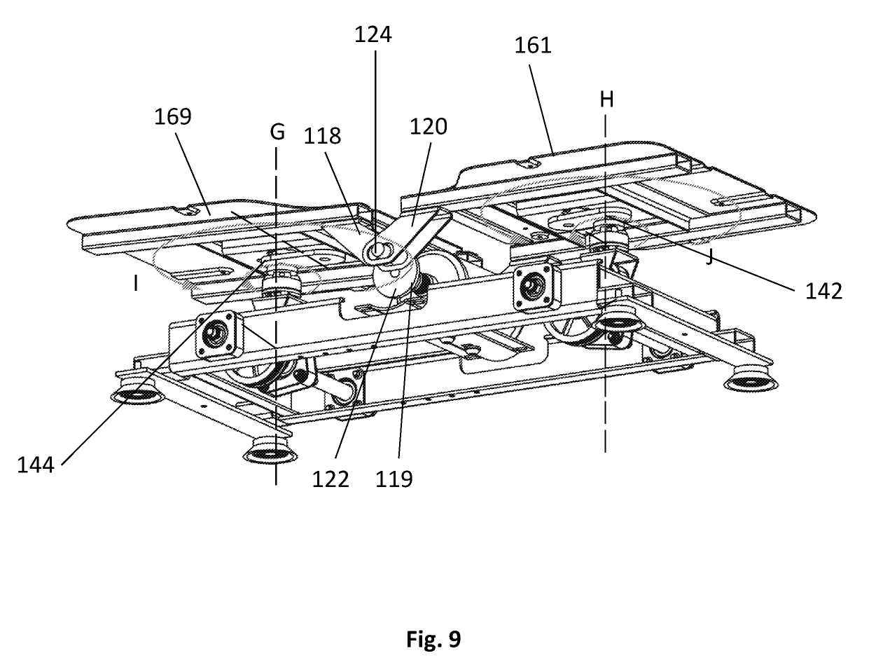

However, in this alternative embodiment, the first 113 and second 115 oscillation mechanisms each include a random orbital drive 114, 116 that is mounted between the eccentric cam and the footplates 161, 169. The orbital drives 114, 116 are arranged to operate independently of the motor 117. The orbital drive 114 is mounted to the underside of the footplate 169 and the orbital drive 116 is mounted to the underside of the footplate 161. The orbital drives rotate about axes G and H respectively (FIG. 8). Axes G, H (the orbital drive axes) are substantially perpendicular to axis D (the motor drive shaft axis). Axis F (a longitudinal axis of the device body) is substantially perpendicular to orbital drive axes G, H and drive shaft axis D. Rotation of the orbital drives 114, 116 about orbital drive axes G, H translates motion to the footplates 161, 169 via links 142, 144 that are each mounted between a respective orbital motor and its respective footplate. An off centre shaft (not shown) extends between each link 142, 144 and its respective orbital drive 114, 116 that causes the connected link to rotate upon rotation of its orbital drive. This, in turn, causes the plates 161, 169 to be rotated with the links 142, 144. The translation of motion from the orbital drives causes the footplates to rotate about an axis substantially perpendicular to the face of the footplate (e.g. axes G, H in FIG. 8). As shown in FIG. 9, the footplate 169 rotates (see arrow I) about axis G and the footplate 161 rotates (see arrow J) about axis H. Further, the speed of both orbital drive motors can be programmed, or can be manually set, to either operate at the same speed, operate at asynchronous speeds, or operate at constantly varying speeds (i.e. to cause relative stochastic movement between the plates). Mounting points between the plates, the oscillating drives and the motor shafts have space to allow the plates to oscillate and laterally translate freely. As such, this embodiment is able to achieve varied frequencies and varied plate rotational movements to further enhance the user experience. As will be evident to the skilled addressee, the disclosed mechanism that provides rotational movement of the footplates is one of many mechanisms that can achieve a similar effect (e.g. whereby the footplates are able to laterally translate along a plane that is substantially perpendicular to the footplate face). In an alternative embodiment, a mechanism may be used to cause the footplates to translate laterally from side to side or forward and back (i.e. lateral movement along an axis of the footplate). In the disclosed embodiment, the rotational movement of the footplate causes a lateral translation (side to side and front to back) of approximately 1 cm. As will be apparent to the skilled addressee, the range of lateral movement can be varied (i.e. anywhere between 0.1 cm and upwards) in dependence on the skill of the user and the body part being exercised.

The device also includes pivot brackets 118, 120 that are mounted between the motor shaft 119 and the footplates 161, 169. Connected to the motor shaft 119 is a disk 122 having an off centre shaft 124 (see also FIG. 8). Thus, rotation of the motor shaft 119 causes rotation of the disc 122 and off centre shaft 124. The off centre shaft 124 is connected to the pivot brackets 118, 120 to move back-and-forth in a slot 140 thereof. Therefore, rotation of the off centre shaft 124 causes the footplates 161, 169 to translate up and down relative to the motor shaft 119. Thus, the amplitude varies constantly. In an alternate embodiment, the size of the eccentric cams 135, 137, or shafts/slots can be varied to cause a variation in amplitude between the two plates. In the illustrated form, the variation in amplitude between adjacent footplates is approximately 1 cm. However, in other embodiments, the variation in amplitude between the footplates (or surface portion if the apparatus is designed for an alternative body part) may be more or less than 1 cm (e.g. a range of between 0.3 cm and 2 cm).

Further embodiments of the exercising apparatus are shown in FIGS. 10 to 17. The primary differences between the embodiments shown in FIGS. 10 to 17 and the embodiments shown in FIGS. 1 to 9 are that the exercise apparatuses are associated with a single platform and in the design of oscillation mechanisms to impart movement to the platform. The embodiments of exercise apparatuses include oscillation mechanisms arranged to impart drive to a platform to oscillate at different frequencies and different amplitudes and substantially in the same direction.

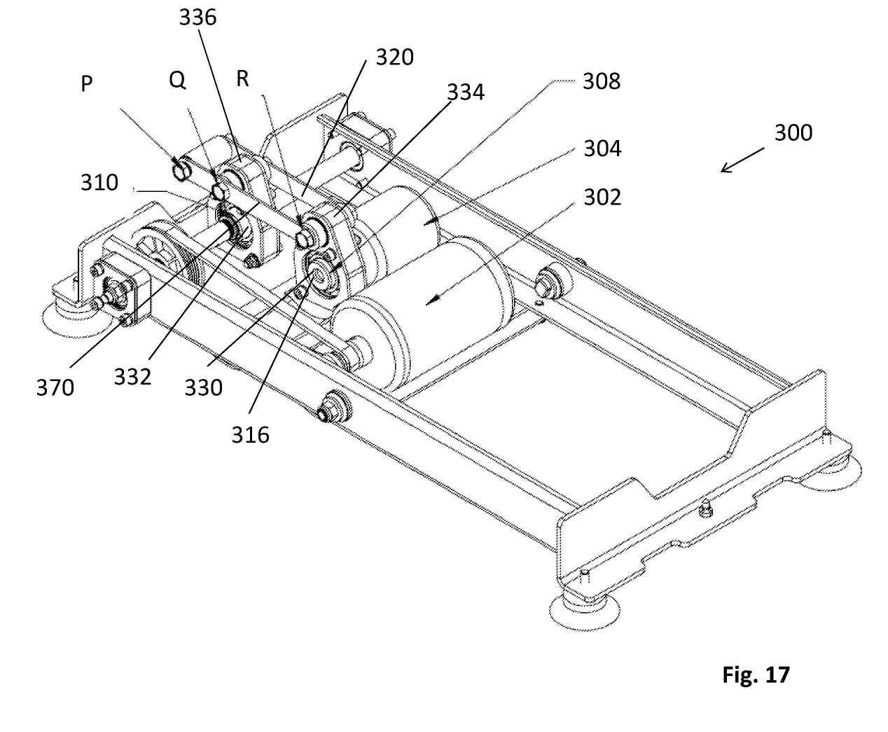

An exercise apparatus 200 is shown with reference to FIGS. 10 to 16, whereas an exercise apparatus 300 is shown in FIG. 17.

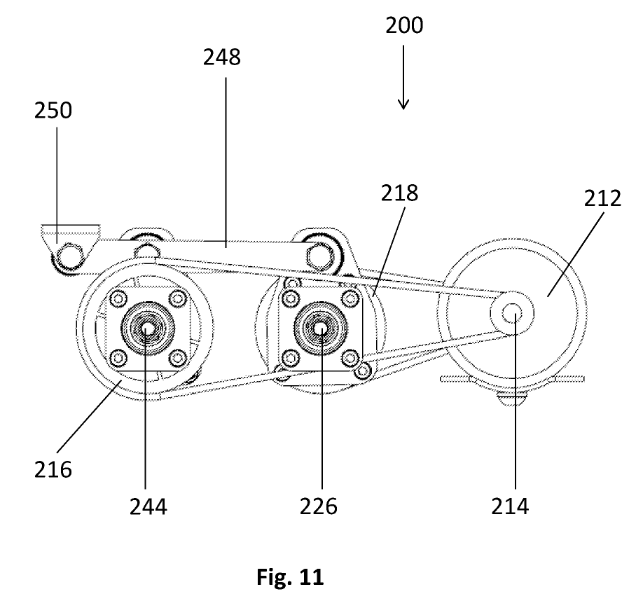

In relation to the apparatus 200, FIG. 10 shows a perspective view, and FIG. 11 shows a side view. The exercise apparatus 200 includes a first oscillation mechanism 202 and a second oscillation mechanism 204. The first oscillation mechanism 202 is arranged to impart drive to the platform to oscillate in a first frequency range and at a first amplitude. The second oscillation mechanism 204 is arranged to impart drive to the platform to oscillate in a second frequency range and a second amplitude. In use, each of the frequency ranges are able to be varied by the user, and are also able to be set by the user to a fixed frequency. Typically in use, the user sets each frequency range to a fixed frequency such that the second frequency is greater than the first frequency, and the first amplitude is greater than the second amplitude. The difference in frequencies and amplitudes caused by the oscillation mechanisms 202, 204 to the platform has been discovered to stimulate muscles during exercise to enhance the user's workout. Additional oscillation mechanisms may be included to impart additional frequency ranges to the platform. Further, one oscillation mechanism may impart more than one frequency range to the platform. All the same advantages as discussed in relation to the embodiments shown in FIGS. 1 to 9 also apply to the embodiments discussed in relation to FIGS. 10 to 16. The body is not able to adapt to the movements caused by the oscillation mechanisms 202, 204, and better training results are achieved.

In the exercise apparatus 200, the first and second oscillation mechanisms 202, 204 use a common first drive motor 212 having a first motor drive shaft 214. The first motor 212 rotates the first motor drive shaft 214 about a first motor axis I. The first oscillation mechanism 202 includes a first translation mechanism 216 that is able to translate the output from the first motor 212 to a first eccentric arrangement 232. The second oscillation mechanism 204 also includes a second translation mechanism 218 that is able to translate the output from the first motor 212 to a second eccentric arrangement 240. It is the first and second translation mechanisms 216, 218 which respectively determine the frequencies of the first and second oscillation mechanisms 202, 204.

In the illustrated embodiment, both the first and second translation mechanisms are in the form of pulley and belt systems 216, 218. A first endless belt 220 extends between a first driven pulley 215 of the first eccentric arrangement 232 and a first driver pulley 219 of the first motor drive shaft 214. When the first motor drive shaft 214 is rotated by the motor 212 it revolves the first driver pulley 219 of the first motor drive shaft 214. This then rotates the belt 220 and the first driven pulley 215. The smaller pulley 219 is driving the rotation because it is connected to the motor 212 which is driving the pulley and belt system 216. The larger pulley 215 is driven round and rotates because of the power provided by pulley 219 of the first motor drive shaft 214. Likewise, a second endless belt 222 extends between a second driven pulley 217 of the second eccentric arrangement 240 and a second driver pulley 221 of the first motor drive shaft 214. As discussed above, the translation mechanisms may be in other forms.

The diameter of the pulley wheel affects the oscillation speed (frequency of oscillation) and thus delivers a mechanical advantage to one or both of the eccentric arrangements. In this regard, the diameter of either pulley 219, 221 of the first motor drive shaft 214 or either pulley 215, 217 of the eccentric arrangements may be of different diameters to affect the frequency of the respective oscillation mechanisms 202, 204.

Pulley wheels 215, 217, 219, 221 are grooved or pitched to retain the belt 220, 222, and the belt 220, 222 is in tension between its respective pulley wheels 215, 217, 219, 221. As a result, friction caused between the belt 220, 220 and the pulleys 215, 217, 219, 221 means that when the driver pulley 219, 221 rotates the driven pulley 215, 217 follows.

In some forms, the speed of the first oscillation mechanism may be in the range of 1-20 Hz. In some forms, the speed of the first oscillation mechanism may be in the range of 2-11 Hz. In some forms, the speed of the second oscillation mechanism may be in the range of 5-50 Hz. In some forms, the speed of the second oscillation mechanism may be in the range of 5-35 Hz. The second oscillation mechanism mostly operates in a higher frequency range than the first oscillation mechanism, but there is some overlap, and in some embodiments, the second oscillation mechanism and the first oscillation mechanism may be operated at the same frequency or the second oscillation mechanism may be operated as a slower frequency than the first oscillation mechanism. Further, each of the oscillation mechanisms may be operated by the user at variable frequencies and are not required to be set by the user at a fixed frequency.

In alternative embodiments, other translation mechanisms such as gearing systems may be utilised to generate different frequencies. Different types of motors may be used such as variable speed motors, or stepped motors etc.

The first eccentric arrangement 232 includes a first cam 234 having a first off centre aperture 236 formed therethrough. The distance that the aperture is off centre affects the magnitude of the movement of the first eccentric arrangement 232. The aperture 236 is arranged to receive the first axle 224 such that rotation of the first axle 224 causes eccentric rotation of the cam 234. The first eccentric arrangement 232 also includes a cam housing 238 within which the cam 234 is mounted. The cam housing 238 includes a follower surface which makes contact with the cam 234 to translate the rotary movement of the cam into substantially linear movement of the cam housing 238 (i.e., reciprocating movement). Rotation of the cam 234 within the cam housing 238 causes the cam housing 238 to move between a raised position and a lowered position.

Like the first eccentric arrangement 232, the second eccentric arrangement 240 also includes a second cam 242 having a second off centre aperture 244, and a second cam housing 246. The second aperture 244 receives the second axle 226, and rotation of the second axle 226 causes rotation of the second cam 242 within the second cam housing 246.

In the illustrated embodiment, the first and eccentric arrangements 232, 240 are identical, and as a result, both have the same magnitude of movement between the raised and lowered positions. Although the movement of the cam housings 238, 246 is substantially linear there may be some lateral component to the movement. The cam housings 238, 246 move in the same vertical plane.

The first oscillation mechanism 202 includes a first axle 224 arranged to rotate about a first axis J. The first axis J is substantially parallel to the first motor axis I. In some embodiments, the axis J may be substantially in the same plane, transverse to and/or perpendicular to the first motor axis L. Likewise, the second oscillation mechanism 204 includes a second axle 226 arranged to rotate about a second axis K. The second axis K is substantially parallel to the first motor axis I, as well as to the first axis J. In some embodiments, the second axis K may be substantially in the same plane, transverse to and/or perpendicular to the first motor axis I, and the first axis J. In use, rotation of the first motor shaft 214 about the axis I drives the first 224 and second 226 axles such that they respectively rotate about axes J and K. The difference in diameters of the pulleys 215, 217 or the motor drive pulleys 219, 221 causes a difference in rotational speed of the first and second axles 224, 226 which causes a difference frequencies of the first and second eccentric arrangements 232, 240.

Both eccentric arrangements 232, 240 operate through a drive element 270 to cause the movement of the platform 210. The reciprocating movement of the oscillation mechanisms 202, 204 are arranged to impart drive to cause the movement of the platform 210 through the drive element 270 which in the illustrated form is in the form of linkage 270 and drive head 250 which engages with an underside of the platform 210.

The linkage 270 includes a pair of arms 248 which are mounted to the first eccentric arrangement 232 and the second eccentric arrangement 240. The linkage 270 also constrains the movement of the cam housings 328, 346 to the movement to the same vertical plane. The connection between the linkage 270 and the cam housings 238, 246 is pivotal to combine and translate the movement of the cam housings 238, 246 between the raised and the lowered positions to the platform 210 about pivot points M and N respectively. The first eccentric arrangement 238 is operating at a slower frequency than the second eccentric arrangement 240. As a result, the movement of the eccentric arrangements 232, 240 is typically out of sync. The linkage 270 combines the movement of the eccentric arrangements 232, 240 that are pivoting in relation to each other at points M and N.

The drive head 250 is mounted at a distal end of the arms 248. As shown, the drive head 250 is in the form of a bracket 250 that is able to pivot in relation to the arms 248 at pivot point L. The combined movement of the eccentric arrangements 232, 240 is imparted to the platform 210 at pivot point L through the drive head 250. The sum of the combined movement imparted to the platform 210 is complex in that it is constantly varying. In alternative embodiments, the drive head may be slideably moveable in relation to the platform.

The eccentric arrangements 232, 240 also impart drive to the platform 210 at respective amplitudes. Although, in the illustrated embodiment, the eccentric arrangements 232, 240 are the same, the translated amplitude imparted to the platform is respectively different. In particular, the eccentric first arrangement 232 imparts a greater amplitude to the platform 210 than the second eccentric arrangement 240. The distance between M and N is greater than the distance between M and L, so the translated amplitude is reduced by a factor corresponding with the ratio between the two distances. The greater the distance between MN in relation to the distance LM then the smaller the amplitude imparted to the platform by the second eccentric arrangement 240. In alternative embodiments, the pivot axis L may be between pivot axes M and N. This will change the distance ratios and therefore change the translated amplitude to the platform. In alternative embodiments, the first eccentric arrangement and the second eccentric arrangement may impart different amplitudes and are not required to be identical.

In some forms, the amplitude of the first eccentric arrangement may be in the range of 5 mm-20 mm amplitude. In some embodiments, the amplitude of the first eccentric arrangement may be approximately 11 mm. In some embodiments, the amplitude of the second eccentric arrangement may be in the range of 0.5 mm-5 mm. In some embodiments, the amplitude of the second eccentric arrangement may be approximately 2 mm. In alternative embodiments, the cam may equally affect the amplitude of the oscillation mechanisms if the aperture is centred but the shape of the cam is irregular. The magnitude of the movement caused by the cam may be varied by changing the distance that the aperture is offset from the centre, or changing the shape of the cam.

The overall effect is an oscillating movement of the platform 210 and when a user is standing on the platform, the user experiences stochastic exercise. The muscles of the user never get an opportunity to adapt to the movement, and thus are constantly being stimulated.

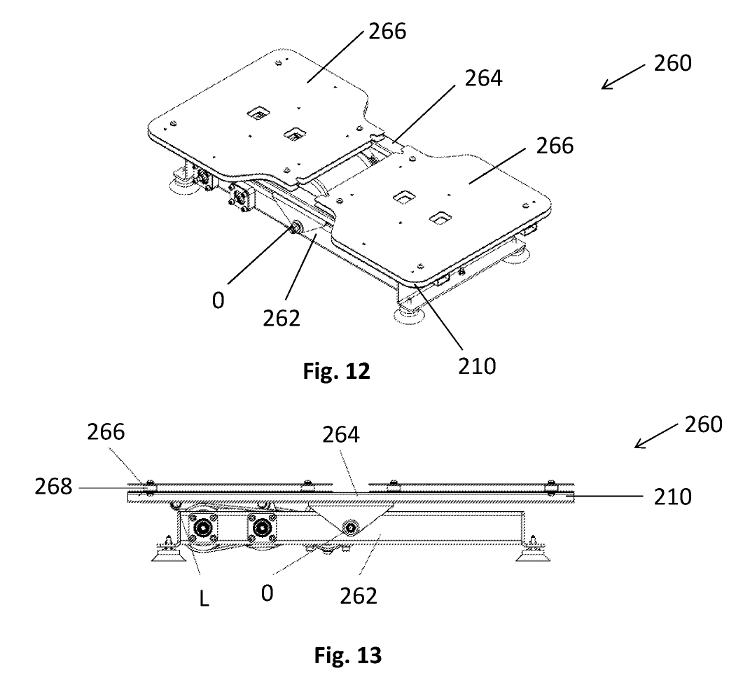

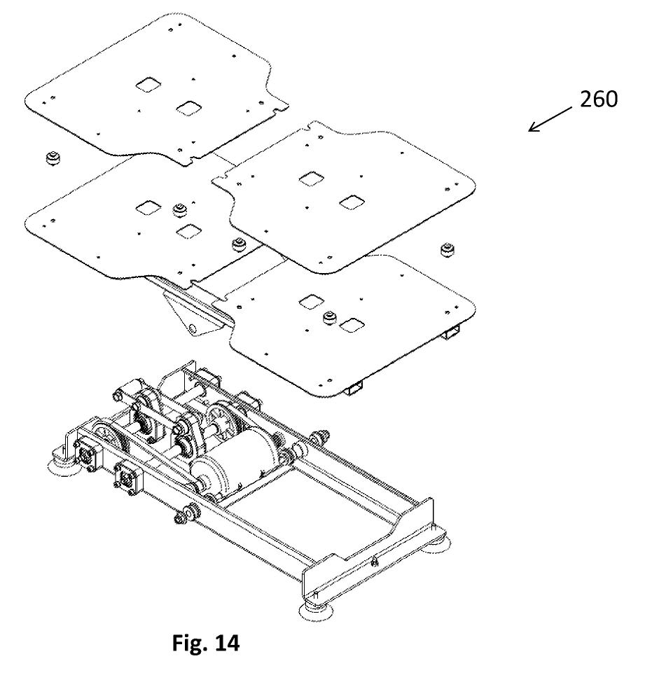

FIGS. 12 to 16 illustrate an embodiment of the exercise machine 260 in assembled (FIGS. 12 and 13) and exploded views (FIGS. 14 to 16). In general, the exercise machine 260 is located in a lower frame 262, and the platform 210 is fixed to an upper frame 264 to enclose the exercise apparatus 260. The upper frame 264 is pivotally connected to the bracket 250 at pivot L and the lower frame 262 is pivotally connected to the upper frame 264 at the platform pivotal axis. Two footplates 266 are fixed to the platform using dampers 268. The dampers 268 allow sympathetic multi directional movement. In an alternative embodiment, the footplates could be mounted directly to the platform without the dampers.

The platform 210 is a single plate that oscillates between the raised and the lowered positions. The movement of the platform 210 is driven at one side of the exercise apparatus 260 by the bracket which is pivotally connected to the eccentric arrangements 232, 240 via the linkage 270. But because the centre of the upper frame 264 is pivotally fixed to the centre of the lower frame 262 (this may be referred to as the main plate axis O), the other side of the platform 210, which is following the driven side of the platform, will equally be affected by the oscillations. The distance between the pivot axis L and the main plate axis O affects the final movement translated to the platform 210.

As discussed in relation to FIG. 7, the machine 260 includes the same major components as the apparatus 1 including a control panel 270, rubber mats 272 for the footplates 266, a variable speed drive 274 for the motor 212 and feet 276 for the lower frame 262.

Now, turning to FIG. 17, a further embodiment of an oscillation apparatus 300 is illustrated. The primary difference between the embodiment of the oscillation apparatus 200 illustrated in FIGS. 10 to 16 and the oscillation apparatus illustrated in FIG. 17 is that two motors 302, 304 independently drive first and second axles 306, 308 of first and second oscillation mechanisms 310, 312. Further, in this embodiment, the second motor 304 is directly engaged with the second eccentric arrangement 316. It should be noted that the second eccentric arrangement may instead be driven by a pulley and belt arrangement, gearing, actuator, etc that is connected to the second motor, or that the first eccentric arrangement may instead be directly driven by a motor.

All of the other features discussed in relation to FIGS. 10 to 16 equally apply in relation to FIG. 17. To adjust the oscillation frequency, the speed of the motors may be adjusted independently, the diameter of the pulleys may be altered, the diameter of the motor axis pulleys may be altered, both motors may be mounted directly to the eccentric arrangement or a combination thereof. In a further variation, gearing, rotational-to-linear actuators, etc. may be used in place of the pulley arrangements.

In the oscillation apparatus illustrated in FIG. 17, the second motor 304 is configured to drive a second eccentric arrangement 316 at a high frequency (i.e. high oscillation speed) and the first motor 302 drives a first eccentric arrangement 314 by a first pulley and belt arrangement 318 at a low frequency (i.e. low oscillation speed). The pulley and belt arrangement 318 driving the first eccentric arrangement 314 reduces the rotational speed by a ratio of 1:3 determined by the pulleys (the motor axle pulley to the eccentric arrangement pulley). It is understood by a person skilled in the art, that this ratio may be any ratio, such as 1:4, depending on the desired frequency of the eccentric arrangement. Further, as each motor 302, 304 is controlled independently, each motor can be turned off entirely independently of the other motor. In the embodiment of FIG. 17, typically there is no reduction in ratio between the second motor 304 and the second eccentric arrangement 316 (i.e. it is a direct drive).

The eccentric arrangements 314, 316 are connected to the platform (not shown in relation to this embodiment) through a drive element in the form of a linkage 370. In the illustrated embodiment, the linkage 370 includes a pair of arms 320 and a bracket (not shown in FIG. 17). The connection points between each eccentric arrangement 314, 316 and the arms 320 are pivot points which pivot about pivot points Q, R, and likewise, the connection between the bracket 322 and the linkage 370 is a pivot point which pivots about pivot point P.

As discussed above, each eccentric arrangement 314, 316 includes a cam 330, 332 that rotates within a cam housing 334, 336. Rotation of each cam within the respective cam housing 334, 336 is translated into substantially linear movement of the cam housing which affects movement of the arms 320 about each pivot axis R, Q. The linkage 370 combines the respective oscillations of the eccentric arrangements 314, 316 and imparts this combined movement to the platform. The distance between R and Q is greater than the distance between P and Q, so the translated amplitude is reduced by a factor corresponding with the ratio between the two distances.

In alternative embodiments, the eccentric arrangements could both be directly connected to respective motors, which are operated at the desired frequencies independently.

The final motion of the platform is dependent on the following factors:
the ratio of the distance PQ to distance QR;
the eccentricity of each of the two eccentric arrangements 314, 316;
the distance from pivot axis P to the main plate axis;
the pulley ratio; and
the rotational speed of each motor.

By manipulating these variables the acceleration, frequency, and amplitude (waveform shape) of the platform can be controlled. These factors are equally applicable to all the embodiments discussed herein.

Although, these further embodiments illustrated in FIGS. 10 to 17 include alternative oscillation mechanisms, the exterior appearance of overall exercise apparatus will resemble the exercise apparatus 1 shown in FIG. 1. It should also be understood that one platform may be used in combination with one footplate, and thus no visible demarcation between footplates is required.

It should be noted that any one of the above features can be used in isolation or in combination. Each feature is able to cause relative stochastic (e.g. substantially random and asynchronous) movement (i.e. rotational/lateral movement, vertical movement, pivotal movement) of the platform of the exercise apparatus. It should also be noted that the detailed mechanisms are examples of mechanisms that are able to cause stochastic movement between the plates. As will be evident to the skilled addressee, various alternate mechanisms can be used to cause stochastic movement of the platform of the exercise apparatus. Further, the apparatus has been detailed in the context of a device that a user is able to stand on. However, variations of the device allow for the footplates to be replaced with alternate surface portions such that the device is suitable to exercise other body parts (e.g. surface portions that allow the user to hold the apparatus, to provide stochastic movement between the users right and left hands, and sit on the device to provide stochastic movement between the users right and left buttocks, to rest the elbows thereon, etc.).

In the claims which follow and in the preceding summary except where the context requires otherwise due to express language or necessary implication, the word “comprising” is used in the sense of “including”, that is, the features as above may be associated with further features in various embodiments.

Variations and modifications may be made to the parts previously described without departing from the spirit or ambit of the disclosure.

1. An exercise apparatus comprising;
a platform configured to support a user thereon;
at least first and second oscillation mechanisms arranged to cause movement of the platform;
the first oscillation mechanism arranged to impart drive to the platform to oscillate in a first frequency range and at a first amplitude; and
the second oscillation mechanism arranged to impart drive to the platform to oscillate in a second frequency range and at a second amplitude; and
wherein the first amplitude is greater than the second amplitude, and
wherein each of the first and second oscillation mechanisms is arranged to generally impart drive to the platform in substantially the same direction.

2. The exercise apparatus according to claim 1, wherein the maximum of the second frequency range is greater than the maximum of the first frequency range, and the minimum of the second frequency range is greater than the minimum of the first frequency range.

3. (canceled)

4. The exercise apparatus according to claim 1, wherein the first and second mechanisms operate through a drive element to cause the movement of the platform.

5. An exercise apparatus according to claim 4, wherein the drive element combines drive imparted from the first and second oscillation mechanisms to cause the movement of the platform.

6. (canceled)

7. The exercise apparatus according to claim 4, wherein the drive element includes a drive head that engages the platform and a linkage connecting the first and second oscillation mechanisms, wherein the drive head is mounted to the linkage.

8. (canceled)

9. (canceled)

10. The exercise apparatus according to claim 7, wherein the first and second oscillation mechanisms include respective first and second eccentric arrangements that oscillate to impart the drive to the platform, wherein the first and second eccentric arrangements are pivotally connected to the linkage.

11. (canceled)

12.-20. (canceled)

21. The exercise apparatus according to claim 10, wherein the first oscillation mechanism further comprises a first motor that causes oscillation of the first eccentric arrangement, and the second oscillation mechanism further comprises a second motor that causes oscillation of the second eccentric arrangement.

22. The exercise apparatus according to claim 21, wherein the first oscillation mechanism is arranged to translate output from the first motor to the first eccentric arrangement to so as to impart drive to the platform to oscillate at the first frequency and at the first amplitude.

23. The exercise apparatus according to claim 22, wherein the first translation mechanism comprises a first driven pulley, a first endless belt and a first driver pulley, and wherein the first endless belt extends between the first driven pulley and the first driver pulley.

24. The exercise apparatus according to claim 23, wherein the second eccentric arrangement is driven by a drive shaft of the second drive motor and rotates about an axis of the second motor shaft drive.

25. The exercise apparatus according to claim 24, wherein the first oscillation mechanism comprises a first axle that is arranged to rotate about a first axis of the first axle, the first axis being substantially parallel to the first motor drive shaft axis, and wherein the first eccentric arrangement comprises a first cam having an off centre mounting, the mounting being arranged to receive the first axle such that rotation of the first axle causes an eccentric rotation of the first cam, and wherein the second eccentric arrangement comprises a second cam having an off centre mounting, the mounting being arranged to receive the second motor shaft such that rotation of the second motor shaft causes an eccentric rotation of the second cam.

26. The exercise apparatus according to claim 25, wherein the first eccentric arrangement further comprises a first cam housing portion housing the first cam such that eccentric rotation of the first cam causes a corresponding substantially linear movement of the first cam housing portion between a raised position and a lowered position.

27. The exercise apparatus according to claim 26, wherein the first cam housing portion is mounted to the drive element, wherein the linkage is pivotally connected to the first cam housing portion.

28. (canceled)

29. An exercise apparatus according to claim 27, wherein the second eccentric arrangement further comprises a second cam housing portion housing the second cam such that eccentric rotation of the second cam causes substantially linear movement of the second cam housing portion between a raised position and a lowered position.

30. The exercise apparatus according to claim 29, wherein the second cam housing portion is mounted to the drive element, wherein the linkage is pivotally connected to the second cam housing portion.

31. (canceled)

32. The exercise apparatus according to claim 1, further comprising an apparatus housing for supporting the platform and the first and second oscillation mechanisms.

33. The exercise apparatus according to claim 32, wherein the platform is pivotally mounted to the apparatus housing such that the platform is able to pivot about a platform pivotal axis.

34. The exercise apparatus according to claim 33, wherein the direction of movement of the first and second oscillation mechanisms is substantially in the same plane perpendicular to the platform pivotal axis.

35. An exercise apparatus comprising;
a platform configured to support a user thereon;
at least first and second oscillation mechanisms arranged to cause movement of the platform;
the first oscillation mechanism arranged to impart drive to the platform to oscillate in a first frequency range and at a first amplitude; and
the second oscillation mechanism arranged to impart drive to the platform to oscillate in a second frequency range and at a second amplitude;
wherein the first and second mechanisms operate through a drive element, the drive element combining drive imparted from the first and second oscillation mechanisms to cause the movement of the platform.

36. The exercise apparatus according to 35, wherein the first and second oscillation mechanisms are able to be operated independently through the drive element to cause the movement of the platform.
